(19) United States
(12) Patent Application Publication
(10) Pub. No.: US 2025/0200895 A1
(43) Pub. Date: Jun. 19, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Yuto YOSHIDA, Kanagawa (JP)

(21) Appl. No.: 18/971,184

(22) Filed: Dec. 6, 2024

(30) Foreign Application Priority Data
Dec. 15, 2023 (JP) 2023-212061

(51) Int. Cl. G06T 17/20; G06T 7/20; G06V 10/74

(52) U.S. Cl. CPC G06T 17/20; G06T 7/20; G06V 10/761

(57) ABSTRACT

Tracking processing is performed so that an overlapping section occurs between adjacent tracks for time-series shape data including a frame group including a 3D model representing the three-dimensional shape of an object. Then, based on results of the tracking processing, tracked time-series shape data without overlapping between adjacent tracks is output by taking one of positions within the overlapping section as a track boundary.

### BACKGROUND

### Field

The present disclosure relates to a tracking technique of three-dimensional shape data of an object.

### Description of the Related Art

In recent years, in the field of video creation, a volumetric video technique has been becoming common, which reconstructs data (generally, called “3D model”) representing the three-dimensional shape of an object within a three-dimensional space and produces a video of the object from a free viewpoint by adding effects by CG. Here, as preprocessing of data compression in a case where the data of a generated 3D model is transferred to a volumetric video generation apparatus or the like, tracking processing of the 3D model is performed. This tracking processing is a technique to associate each component of the three-dimensional shape represented by the 3D model with each other between frames in a series of frame groups configuring a moving image.

For example, in a case of tracking processing for a 3D model in the mesh format, the state is brought about where a common topology is maintained in the tracking range (frame section in which the vertex of a polygon configuring the mesh is tracked. In the following, called “track”). Consequently, by moving the vertex position of the polygon configuring the mesh, it is possible to implement the representation of a smooth change in shape in each frame within the track. However, at the portion at which the track switches to another, the common topology is not maintained and further, even in a case another track performs tracking for the same correct shape as that of the track of its own, the shapes do not match completely, and therefore, a difference in shape occurs between tracks. Particularly, in a case where video representation depending on the shape is performed, such as rendering with relighting added, the change in shape at the time of switching of tracks appears as an abrupt change in video, and therefore, a feeling of incongruity is given to a viewer. FIG. 17A to FIG. 17D are each a diagram showing one example in which a discontinuous transition occurs in the video at the portion at which the track switches to another, and also showing each state in a case where time elapses from the frame in FIG. 17A toward the frame in FIG. 17D. In this example, tracks switch between FIG. 17B and FIG. 17C (frames in FIG. 17A and FIG. 17B belong to the same track and frames in FIG. 17C and FIG. 17D belong to the same track). It can be seen that the change in the shape of the back portion of a person is particularly large before and after tracks switch.

### SUMMARY

The present disclosure discloses a technique to reduce a difference in shape between tracks in tracking processing of a 3D model.

The image processing apparatus according to the present disclosure has: one or more memories storing instructions; and one or more processors executing the instructions for: obtaining time-series shape data including a frame group consisting of a plurality of frames, each frame including a 3D model representing a three-dimensional shape of an object; performing tracking processing for the time-series shape data so that an overlapping section occurs between adjacent tracks, wherein the track indicates a frame section, which is a section in which a component of the 3D model is tracked between frames and in which a common topology is maintained; and outputting tracked time-series shape data without overlapping section between adjacent tracks by taking one of positions within the overlapping section as a track boundary based on results of the tracking processing.

Further features of the present disclosure will become apparent from the following description of exemplary embodiments with reference to the attached drawings.

### BRIEF DESCRIPTION OF THE DRAWINGS

FIG. 1 is a function block diagram showing a logic configuration (software configuration) of an image processing apparatus;

FIG. 2 is a block diagram showing a hardware configuration of the image processing apparatus;

FIG. 3 is a flowchart showing a flow of the operation of the image processing apparatus according to a first embodiment;

FIG. 4 is a diagram explaining a process of tracking processing in the first embodiment;

FIG. 5 is a flowchart showing details of tracking processing;

FIG. 6 is a flowchart showing details of track boundary determination processing according to the first embodiment;

FIG. 7 is a diagram explaining track boundary determination processing;

FIG. 8 is a diagram explaining the way an output mesh is generated;

FIG. 9 is a flowchart showing a flow of the operation of an image processing apparatus according to a second embodiment;

FIG. 10 is a diagram explaining correction of a mesh shape according to the second embodiment;

FIG. 11 is a diagram showing a correction example of a mesh;

FIG. 12 is a diagram explaining a weight in a case where an intermediate SDF is calculated;

FIG. 13A to FIG. 13C are each a diagram showing a variation of a correction method;

FIG. 14 is a flowchart showing a flow of the operation of an image processing apparatus according to a third embodiment;

FIG. 15 is a diagram explaining correction of a point cloud shape according to the third embodiment;

FIG. 16 is a diagram showing a correction example of a point cloud: and

FIGS. 17A to 17D are diagrams explaining a problem to be solved.

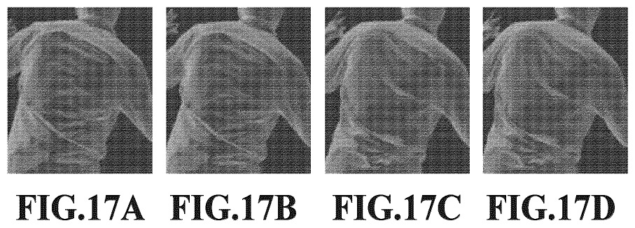

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### Definition of Terms

In the present specification, “object” means a three-dimensional object, such as a person. Further, “point” means an element in a case where the three-dimensional shape of an object is represented, which is indicated by one coordinate in a three-dimensional space, and “point cloud format” refers to a data format of a 3D model representing the surface position of an object by a set of one or more points. Further, “polygon” means a polygonal surface having three or more points as vertices and “mesh format” refers to a data format of a 3D model representing the surface shape of an object by a set of polygons. Furthermore, it is assumed that the data of a frame group including a plurality of 3D models representing the three-dimensional shape of each of a plurality of objects in each continuous frame, which is the target of tracking processing, is called “continuous shape data” or “time-series shape data”. Then, it is also assumed that the continuous shape data in which the 3D model is represented in the mesh format is called “continuous mesh data” and that in which the 3D model is represented in the point cloud format is called “continuous point cloud data”.

### First Embodiment

In the present embodiment, an aspect is explained in which tracking processing is performed first for continuous mesh data so that an overlapping section occurs between tracks and a track boundary is determined based on the degree of similarity in tracked meshes (meshes for which tracking has been performed. In the following, “tracked something” means something for which tracking has been performed) in both tracks overlapping each other.

### Logic Configuration of Image Processing Apparatus

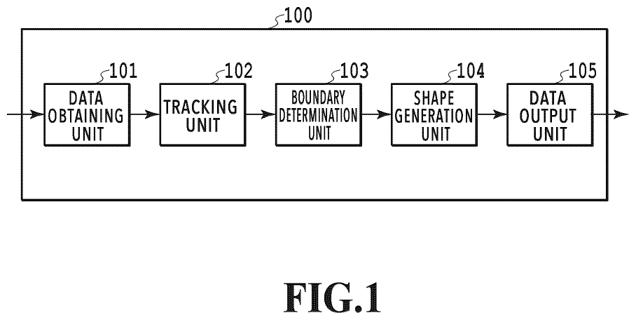

FIG. 1 is a function block diagram showing the logic configuration (software configuration) of an image processing apparatus according to the present embodiment. An image processing apparatus 100 has a data obtaining unit 101, a tracking unit 102, a boundary determination unit 103, a shape generation unit 104, and a data output unit 105. In the following, each function unit is explained.

The data obtaining unit 101 obtains continuous mesh data, which is the target of tracking processing. In this case, on a condition that a plurality of 3D models in the mesh format is included in each frame configuring the continuous mesh data, it is assumed that identification information (object ID) capable of identifying the object corresponding to each individual 3D model is included.

The tracking unit 102 performs tracking processing for each object for the continuous mesh data obtained by the data obtaining unit 101. In this case, first, tracking is performed so that part of each track overlaps part of another adjacent track, that is, so that an overlapping section occurs between adjacent tracks, and then a track boundary is determined. In a case of the 3D model in the mesh format, the method (see US 2017/0024930) is adopted, which makes the index of the vertex common between frames by tracking the vertex of the polygon between frames, which is the component of the mesh of the frame (in the following, keyframe) from which tracking is started. By making index information on the mesh common between frames, it is possible to represent continuous mesh data in the format of “keyframe +difference”.

The boundary determination unit 103 determines the boundary between two adjacent tracks based on the degree of similarity in the tracked meshes in the overlapping section that occurs by the above-described tracking processing. Due to this, one track to which each frame within the overlapping section should belong is determined and one of tracks is allocated to each frame configuring the input continuous mesh data. In the following, in the present specification, the track in the state where an overlapping section immediately after tracking processing occurs is called “provisional track” and the track in the state where one track is allocated to each frame based on the determined boundary is called “output track”.

The shape generation unit 104 selects a mesh for output, which is associated with each frame belonging to the output track, from among tracked meshes obtained by tracking processing. Due to this, tracked continuous mesh data is generated.

The data output unit 105 outputs the tracked continuous mesh data generated by the shape generation unit 104.

### Hardware Configuration of Image Processing Apparatus

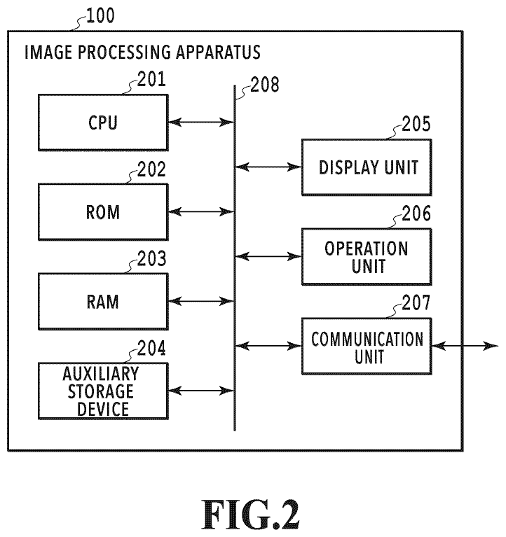

FIG. 2 is a block diagram showing the hardware configuration of the image processing apparatus according to the present embodiment. The image processing apparatus 100 has, as hardware a common computer comprises, a CPU 201, a ROM 202, a RAM 203, an auxiliary storage device 204, a display unit 205, an operation unit 206, a communication unit 207, and a bus 208 as shown in FIG. 2 as one example.

The CPU 201 implements each function unit the image processing apparatus 100 shown in FIG. 1 comprises by using programs or data stored in the ROM 203 or the RAM 203. The image processing apparatus 100 may have one or a plurality of pieces of dedicated hardware different from the CPU 201 and the dedicated hardware may perform at least part of the processing that is otherwise performed by the CPU 201. As examples of the dedicated hardware, there are ASIC, FPGA, DSP (Digital Signal Processor) and the like. The ROM 202 stores programs and the like that do not need to be changed. The RAM 203 temporarily stores programs or data, which is supplied from the auxiliary storage device 204, data that is supplied form the outside via the communication unit 207, or the like. The auxiliary storage device 204 includes, for example, a hard disk drive or the like and stores various pieces of data, such as image data or voice data.

The display unit 205 includes, for example, a liquid crystal display, an LED or the like and displays a GUI (Graphical User Interface) for a user to operate the image processing apparatus 100 or browse necessary information, and the like. The operation unit 206 includes, for example, a keyboard, a mouse, a touch panel or the like and receives the operation by a user and inputs various instructions to the CPU 201. The CPU 201 operates also as a display control unit configured to control the display unit 205 and an operation control unit configured to control the operation unit 206. The communication unit 207 is used for communication with a device outside the image processing apparatus 100. For example, in a case where the image processing apparatus 100 is connected with an external device by wire, a communication cable is connected to the communication unit 207. In a case where the image processing apparatus 100 has a function of wirelessly communicating with an external device, the communication unit 207 comprises an antenna. The bus 208 connects each unit comprised by the image processing apparatus 100 and transmits information.

In the present embodiment, explanation is given on the assumption that the display unit 205 and the operation unit 206 exist inside the image processing apparatus 100, but it may also be possible for at least one of the display unit 205 and the operation unit 206 to exist as another device outside the image processing apparatus 100.

### Operation of Image Processing Apparatus 100

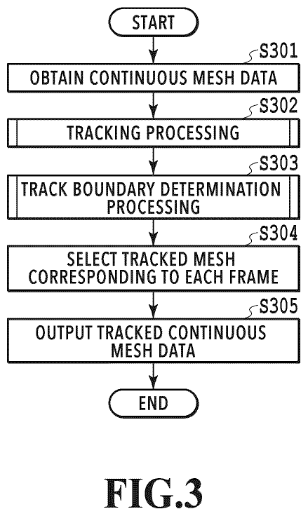

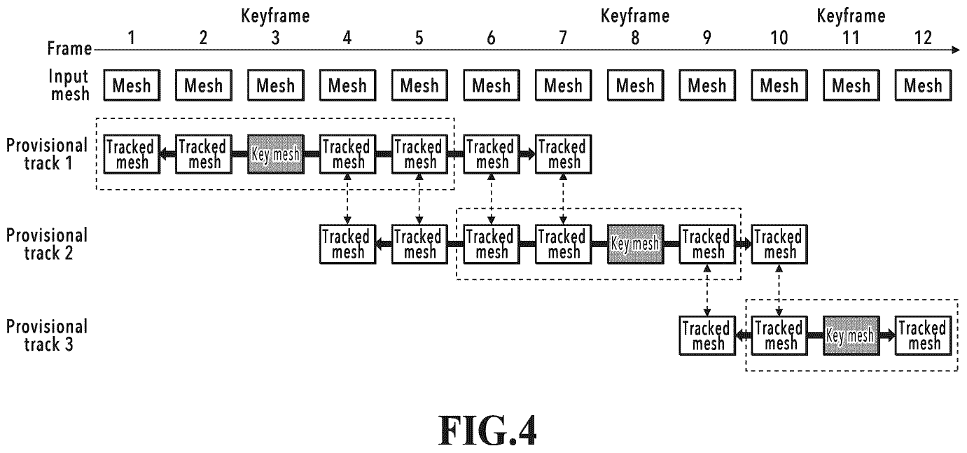

FIG. 3 is a flowchart showing a flow of the operation of the image processing apparatus 100 according to the present embodiment. FIG. 4 is a diagram explaining a process of tracking processing in the present embodiment, schematically showing the way an overlapping section occurs between two adjacent tracks. In the following, with referent to FIG. 3 and FIG. 4, the operation of the image processing apparatus 100 according to the present embodiment is explained. In the following explanation, a symbol “S” means a step.

At S301, the data obtaining unit 101 obtains continuous mesh data from an external PC or the like. This continuous mesh data is aggregate data in which a 3D model in the mesh format representing the three-dimensional shape of an object is arranged in a time series for each frame, which is obtained by measuring the object over time. “Input mesh” in FIG. 4 indicates continuous mesh data corresponding to 12 frames obtained as a processing target.

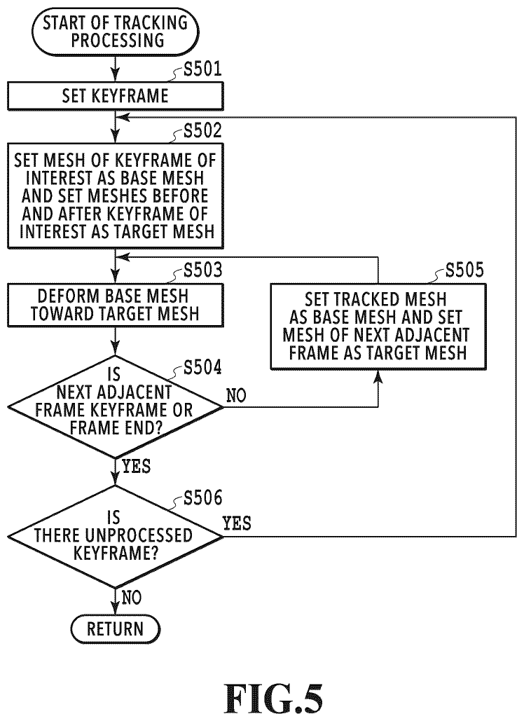

At S302, the tracking unit 102 performs tracking processing for the continuous mesh data obtained at S301 for each object so that an overlapping section occurs between adjacent tracks. FIG. 5 is a flowchart showing details of tracking processing. Here, a detailed explanation is given with reference to the flow in FIG. 5.

### Details of Tracking Processing

At S501, a keyframe is set, which is taken as a reference in a case where tracking is performed for a group of frames configuring continuous mesh data. The keyframe is set at predetermined intervals for the group of frames configuring the continuous mesh data. Alternatively, it may also be possible to set a specific frame as a keyframe, which is determined based on a predetermined evaluation value, such as the amount of movement, the surface area and the like of the mesh associated with each frame. The mesh associated with the frame set as the keyframe is called “key mesh” for convenience. In the example in FIG. 4 described above, among all the 12 frames, each of the third, the eighth, and the eleventh frames is set as a keyframe and the mesh associated with each of these three frames is “key mesh”.

At S502, the key mesh associated with the keyframe of interest among the keyframes set at S501 is set as a base mesh and each of the meshes associated with the frames immediately before and after the keyframe of interest is set as a target mesh. Here, the reason both the frames immediately before and after the keyframe of interest are taken as a target mesh is for performing tracking processing in both directions of a time-series direction and a reverse time-series direction with the keyframe as a reference. The processing after S503 is performed in parallel or in order in each of the time-series direction and the reverse time-series direction.

At S503, processing to deform the base mesh is performed so that the difference from the surface structure of the target mesh becomes small. Here, as a specific method of deforming the base mesh toward the target mesh, for example, the ICP (Iterative Closest Point) method can be utilized. Due to this, the tracked mesh is obtained as the results of deforming the base mesh so that the error from the shapes of the meshes associated with the frames immediately before and after the keyframe of interest becomes small while maintaining the topology of the key mesh.

At S504, whether or not the next adjacent frame is the keyframe or the frame end is determined and the next processing is allocated. Here, the “adjacent frame” is explained. In the example in FIG. 4 described above, it is assumed here that the keyframe of interest is the third frame. In a case of the tracking in the time-series direction, the processing at S502 is performed by taking the fourth frame that is ahead in terms of time as the “frames immediately before and after the keyframe of interest”, and therefore, each of the fifth and subsequent fames is the “adjacent frame” in this case. On the other hand, in a case of the tracking in the reverse time-series direction, the processing at S502 is performed by taking the second frame that is behind in terms of time as the “frames immediately before and after the keyframe of interest”, and therefore, the first frame is the “adjacent frame” in this case. In a case where the adjacent frame thus determined is the keyframe or the frame end, the processing at S506 is performed next and in a case where the adjacent frame is not the keyframe or the frame end, the processing at S505 is performed next. The “frame end” means the top frame or the last frame in the group of frames configuring the continuous mesh data.

At S505, the tracked mesh obtained at S503 is set as the base mesh and further the mesh associated with the next adjacent frame is set as the target mesh. In a case where the base mesh and the target mesh are updated as described above, the processing returns to S503 and the same processing is repeated.

At S506, whether or not the above-described processing has been completed by taking all the keyframes set at S501 as the target is determined. In a case where the results of the determination indicate that there is an unprocessed keyframe, the processing returns to S502 and the processing is continued by determining the next keyframe of interest. On the other hand, in a case where the processing has been completed for all the keyframes, this processing is exited and the processing returns to the flowchart in FIG. 3.

The above is the contents of the tracking processing. Due to this, for example, in the example in FIG. 4, it is possible to obtain tracked continuous mesh data including provisional tracks 1 to 3. In the example shown in FIG. 4, the sections of the fourth to seventh frames overlap between the provisional track 1 and the provisional track 2 and the sections of the ninth and tenth frames overlap between the provisional track 2 and the provisional track 3. That is, in the provisional tracked continuous mesh data, each frame within the overlapping section belongs to two tracks. At S502, it may also be possible to set a simple mesh that is obtained by simplifying the key mesh as the target mesh in place of the key mesh associated with the keyframe. Due to this it is possible to increase the speed of the processing. Explanation is returned to the flowchart in FIG. 3.

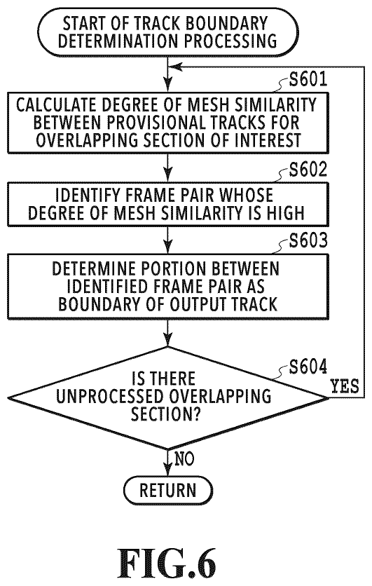

At S303, the boundary determination unit 103 performs processing to determine a track boundary for obtaining an output track without overlapping section between adjacent tracks based on the difference in shape between provisional tracks for the provisional tracked continuous mesh data obtained at S302. FIG. 6 is a flowchart showing details of track boundary determination processing according to the present embodiment. Here, a detailed explanation is given with reference to the flow in FIG. 6.

### Details of Track Boundary Determination Processing

At S601, the degree of similarity in the tracked mesh between provisional tracks is calculated for each frame for the overlapping section of interest among the overlapping sections included in the processing-target provisional tracked continuous mesh data. In the example in FIG. 4, it is assumed that the overlapping section of interest is the fourth to seventh frames. In this case, the degree of similarity between the tracked mesh associated with the provisional track 1 and the tracked mesh associated with the provisional track 2 is calculated in each of the fourth to seventh frames. The degree of similarity here may be an evaluation value, such as the Hausdorff distance based on the shape represented by the mesh, or an evaluation value, such as the cosine similarity based on the normal of the mesh.

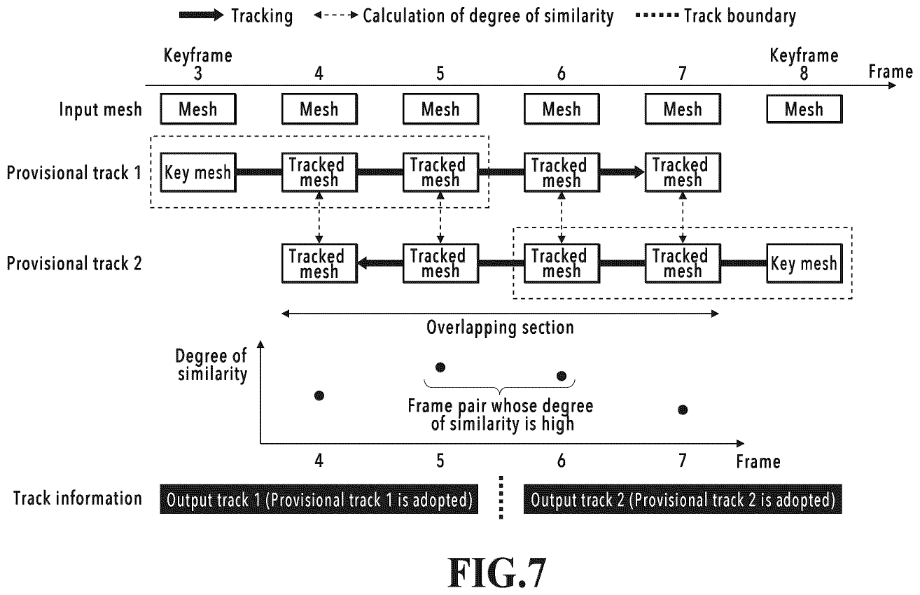

At S602, based on the degree of mesh similarity calculated for each frame for the overlapping section of interest, a frame pair whose degree of mesh similarity is high is identified. This frame pair is a pair including two frames adjacent to each other. For example, a combination of the frame whose degree of mesh similarity is the highest among each frame included in the overlapping section and the frame of the frames adjacent to the aforementioned frame, whose degree of mesh similarity is higher, is identified as the frame pair whose degree of mesh similarity is high. Alternatively, it may also be possible to identify a combination of two frames adjacent to each other among each frame included in the overlapping section, whose total sum of the degrees of mesh similarity is the maximum, as the frame pair whose degree of mesh similarity is high. FIG. 7 is a diagram explaining the way the track boundary determination processing is in a case where the overlapping section of interest is the fourth to seventh frames. In FIG. 7, the graph in the center shows the degree of mesh similarity calculated in each frame of the fourth to seventh frames and in this example, the combination of the fifth frame and the sixth frame is identified as the frame pair whose degree of mesh similarity is high.

At S603, processing to resolve the overlapping state in the two provisional tracks relating to the overlapping section of interest is performed with the portion between the frame pair identified at S602 as a track boundary. Due to this, the two provisional tracks relating to the overlapping section of interest are respectively changed into output tracks without overlapping state. The example in FIG. 7 described above shows that the frames up to the fifth frame are “output track 1” and the frames after the sixth frame are “output track 2” because the track boundary is between the fifth frame and the sixth frame.

At S604, whether or not the above-described processing has been completed by taking all the overlapping sections included in the provisional tracked continuous mesh data as a target is determined. In a case where the results of the determination indicate that there is an unprocessed overlapping section, the processing returns to S601 and the next overlapping section is determined, and the same processing is continued. On the other hand, in a case where the processing has been completed for all the overlapping sections, this processing is exited and the processing returns to the processing in the flowchart in FIG. 3.

The above is the contents of the track boundary determination processing. Due to this, the data format is changed into the data format in which each frame included in the tracked continuous mesh data belongs to one track. However, in this stage, the track boundary is just determined but the tracked mesh associated with each frame is not determined yet, and therefore, at subsequent S304, the tracked mesh is associated with each frame. Explanation is returned to the flowchart in FIG. 3.

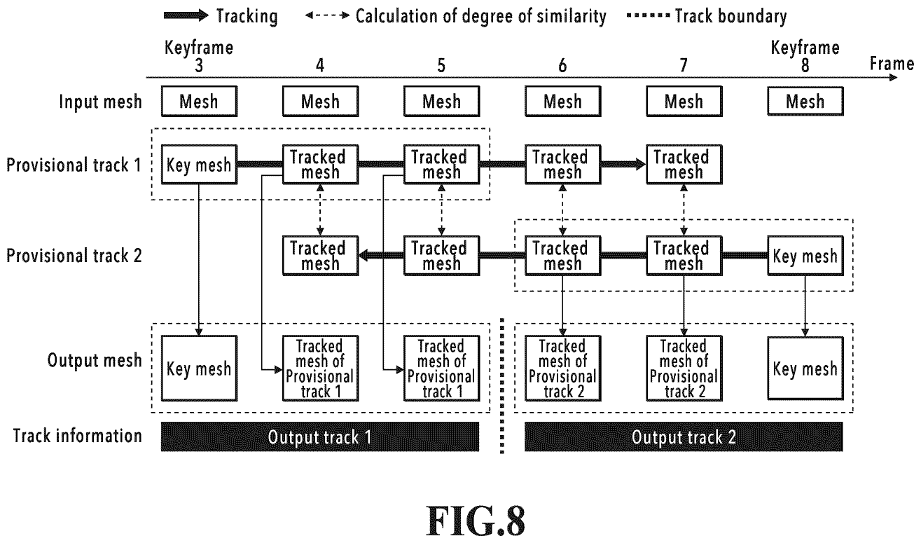

At S304, the shape generation unit 104 performs processing to select the tracked mesh that is taken as the mesh corresponding to each frame configuring the output track (in the following, called “output mesh”). Specifically, processing to select the tracked mesh in the provisional track that is adopted as the output track as the output mesh is performed for each frame included in the overlapping section. FIG. 8 is a diagram explaining the way the tracked mesh as the output mesh is selected in the example in FIG. 7 described previously. For the fourth frame and the fifth frame of the output track 1, the tracked meshes associated with the fourth frame and the fifth frame in the provisional track 1 are selected respectively as the output mesh. Further, for the sixth frame and the seventh frame of the output track 2, the tracked meshes associated with the sixth frame and the seventh frame in the provisional track 2 are selected respectively as the output mesh. For the keyframe, the already associated key mesh is maintained as the output mesh as it is.

At S305, the data output unit 105 outputs the tracked continuous mesh data in which the output mesh is associated with each frame of the output track, which is obtained by the processing up to this point, along with the track information indicating the configuration of the output track. The above is the flow of the operation in the image processing apparatus 100 according to the present embodiment.

### Modification Example

In the tracking processing (S302) of the present embodiment, tracking is performed by taking the section from the keyframe to the next keyframe as one provisional track, but this is not limited. It is only required for an overlapping section to be generated between tracks adjacent to each other by the tracking in two directions, that is, in the time-series direction and in the reverse time-series direction. That is, it is sufficient to perform tracking in two directions with the number of frames exceeding half the interval between two continuous keyframes and for example, in a case where the keyframe interval is five frames, it is sufficient to perform tracking with three or more frames and in a case where the keyframe interval is six frames, it is sufficient to perform tracking with four or more frames. Further, the tracking processing may be tracking in one of the directions. In a case where tracking is performed in one direction, it is sufficient to perform tracking up to the frame several frames ahead beyond the adjacent keyframe. That is, it is sufficient to determine YES in a case where the next adjacent frame is “frame several frames ahead beyond the next keyframe or frame end” at S504 in the flow in FIG. 5 described above. Due to this, it is also possible to generate an overlapping section between tracks adjacent to each other in the tracking in one direction.

As above, according to the present embodiment, the tracking processing is performed so that an overlapping section occurs between tracks adjacent to each other for the input continuous shape data and based on the degree of similarity in the tracked shape between provisional tracks, the boundary of the output track without overlapping section is determined. Due to this, the change in the object shape in a case where tracks switch is suppressed and it is possible to cause a rendering video to make a smooth transition between frames.

### Second Embodiment

With the method of the first embodiment, in a case where the degree of similarity in the tracked mesh is low throughout the entire overlapping section, the difference in the shape of the output mesh does not decrease sufficiently before and after the frame at which tracks switch, and therefore, there remains such a problem that the abrupt change in video cannot be suppressed sufficiently. Consequently, an aspect is explained as a second embodiment in which the tracked mesh selected as the output mesh is corrected so that the difference in the shape of the output mesh decreases sufficiently before and after the frame at which the tracks switch. Explanation of the contents common to those of the first embodiment, such as the logic configuration and the hardware configuration of the image processing apparatus, is omitted and in the following, different points are explained mainly.

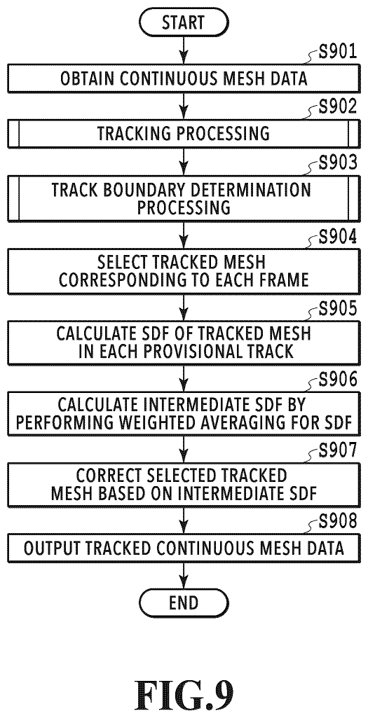

FIG. 9 is a flowchart showing a flow of the operation of the image processing apparatus 100 according to the present embodiment. In the following, with reference to FIG. 9, the operation of the image processing apparatus 100 according to the present embodiment is explained. In the following explanation, a symbol “S” means a step.

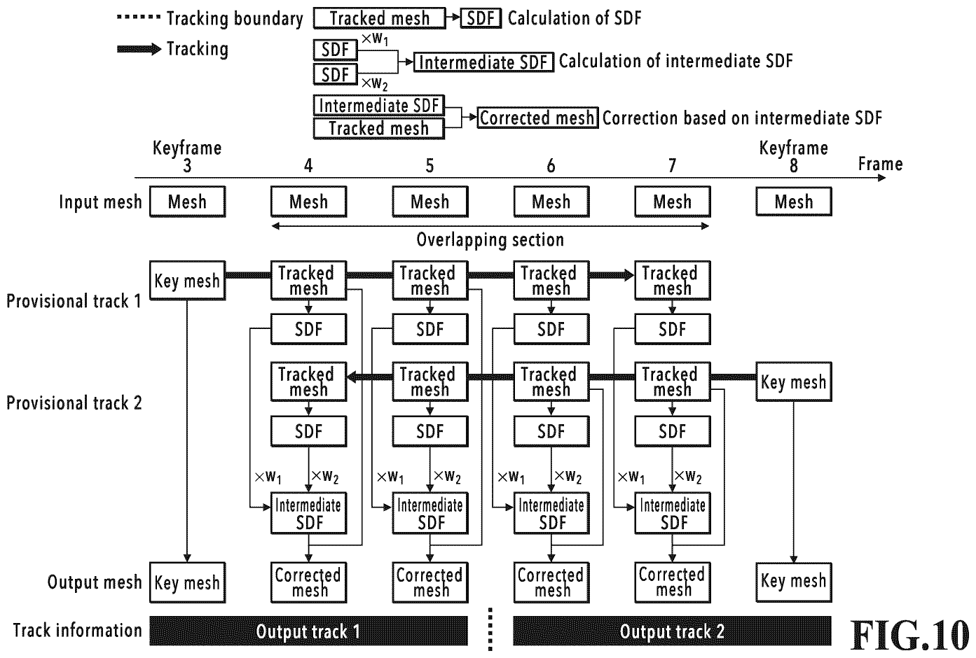

S901 to S904 correspond to S301 to S304 respectively in the flow in FIG. 3 of the first embodiment, and therefore, a detailed explanation is omitted. By the processing up to this point, the data format has been changed into that in which each frame included in the provisional tracked continuous mesh data belongs to one track. At the subsequent steps, processing to correct the tracked mesh selected as the output mesh for each frame for a smoother transition of the mesh shape is performed. FIG. 10 is a diagram explaining the way the processing at S905 and the subsequent steps in a case where the overlapping section of interest is the fourth to seventh frames is applied on a condition that the continuous mesh data corresponding to 12 frames shown in FIG. 4 is the processing target.

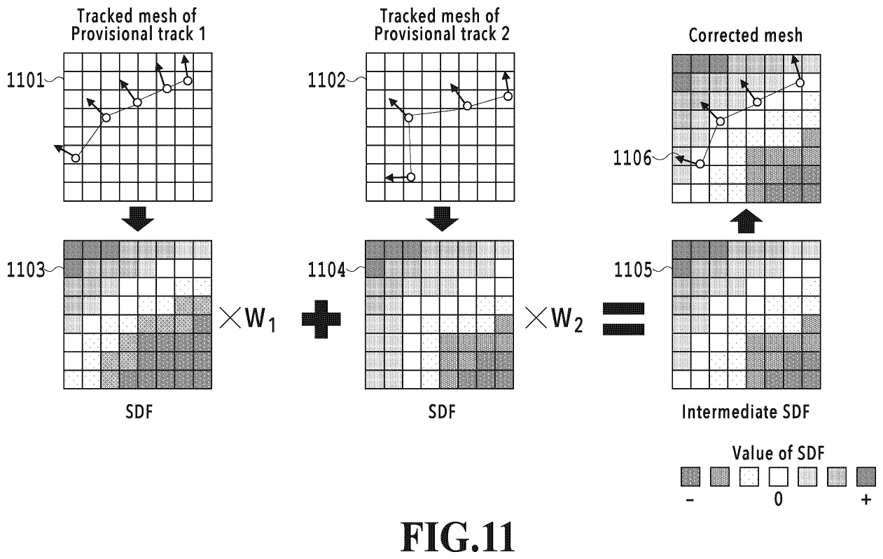

At S905, the shape generation unit 104 calculates a signed distance field (SDF) for the tracked mesh in each provisional track. For the calculation of this SDF, for example, it is possible to use a publicly known method disclosed in Japanese Patent Laid-Open No. 2006-39622. FIG. 11 shows, as one example, an SDF 1103 calculated from a tracked mesh 1101 of a provisional track 1 in FIG. 10 and an SDF 1104 calculated from a tracked mesh 1102 of a provisional track 2. Here, for convenience, the tracked mesh and the SDF are represented two-dimensionally in FIG. 11, but the actual tracked mesh and the SDF have three-dimensional information.

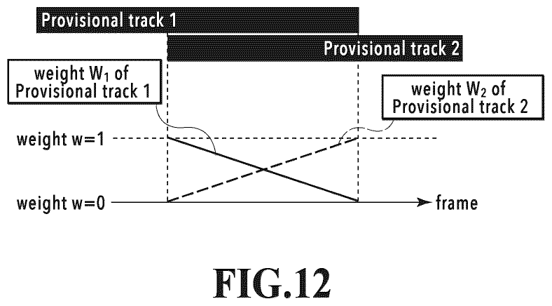

At S906, the shape generation unit 104 calculates an intermediate SDF for each frame included in the overlapping section based on the SDF calculated at S905. In the example in FIG. 10 described previously, in each of the fourth to seventh frames, the intermediate SDF of the SDF 1103 of the tracked mesh 1101 of the provisional track 1 and the SDF 1104 of the tracked mesh 11012 of the provisional track 2 is calculated respectively by calculating the weighted average of both SDFs. FIG. 12 is a diagram explaining the weight that is used in a case where the intermediate SDF is calculated for each frame in the overlapping section of the provisional track 1 and the provisional track 2 in FIG. 10. Here, in a case where the weight for the provisional track 1 is taken to be w1 and the weight for the provisional track 2 is taken to be w2, as shown in FIGS. 12, w1 and w2 are each set to a value in accordance with the number of frames from each frame to the adjacent keyframe. For example, in the example in FIG. 10, the third frame and the eighth frame are the keyframe and the interval is five frames. Then, for the fourth frame, the provisional track 1 is four frames distant to the adjacent keyframe and the provisional track 2 is one frame distant to the adjacent keyframe. Consequently, the weight in this case is determined as w1=⅘ and w2=⅕. By changing the weight linearly in accordance with the number of frames to the adjacent keyframe as described above, it is possible to cause the mesh shape to make a transition smoothly between tracks. In this manner, as shown in FIG. 11, an intermediate SDF 1105 is obtained by calculating the weighted average applying the weight w1=⅘ to the SDF 1103 and the weight w2=⅕ to the SDF 1104. Here, as an example, w1 and w2 are determined by referring to the number of frames from the keyframe, but the determination method is not limited to this and it is only required that w1+w2=1.0 be kept. For example, w1 may be determined to be 0.5 and w2 to be 0.5 in all the frames, or w1 and w2 may be determined based on a function having a point of inflection, such as the sigmoid function.

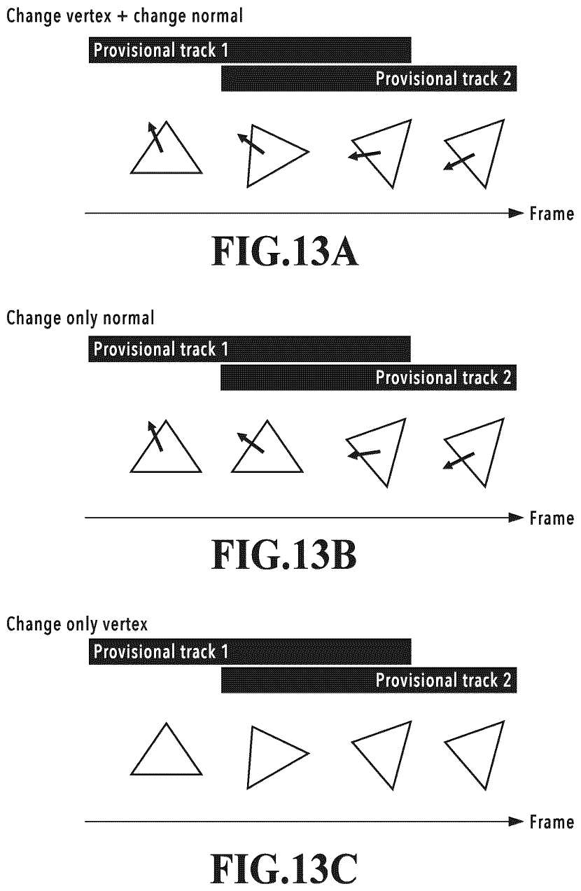

At S907, the shape generation unit 104 corrects the tracked mesh selected as the output mesh in each frame based on the intermediate SDF calculated for each frame at S906. As the contents of the correction, for example, there is a method of correcting the position of the vertex and the normal (arrow attached to the triangular polygon) of the polygon while maintaining the topology of the mesh as shown FIG. 13A. In a case of this method, first, the vertex of the polygon is moved until the value of the SDF reaches 0 based on the local value of the intermediate SDF and the normal is changed based on the local inclination of the SDF of the coordinates after the movement. In the example in FIG. 11, the correction example is shown in which vertex coordinates (white circles) and the normals (arrows) of the polygon configuring the tracked mesh 1102 of the provisional track 2 are changed based on the calculated intermediate SDF 1105. In this manner, the tracked mesh selected as the output mesh at S904 is corrected. For the keyframe, the already associated key mesh is maintained as the output mesh as it is and this is the same as in the first embodiment.

At S908, the data output unit 105 outputs the tracked continuous mesh data in which the corrected tracked mesh is associated with each frame of each output track as the output mesh, which is obtained by the processing up to this point, along with the track information thereon. In the example in FIG. 10, with the third frame belonging to the output track 1, the key mesh is associated, and with the fourth frame and the fifth frame, the corrected mesh of the tracked mesh of the provisional track 1 is associated respectively as the output mesh. Then, with the sixth frame and the seventh frame belonging to the output track 2, the corrected mesh of the tracked mesh of the provisional track 2 is associated, and with the eighth frame, the key mesh is associated respectively as the output mesh. The above is the flow of the operation in the image processing apparatus 100 according to the present embodiment.

### Modification Example 1

In the present embodiment, as in the first embodiment, the track boundary is determined based on the degree of mesh similarity between the provisional tracks and after that, the SDF of the tracked mesh is calculated, but this is not limited. For example, it may also be possible to calculate the SDF of each tracked mesh prior to the determination of the track boundary and determine the track boundary based on the degree of similarity in the obtained SDF.

### Modification Example 2

In the present embodiment, the correction example is explained in which the vertex coordinates and the normal of the polygon are changed in the correction of the tracked mesh, but this is not limited. For example, it is possible to suppress the abrupt change in luminance due to relighting by the correction to change only the normal as shown in FIG. 13B. Further, the correction to change only the vertex coordinates as shown in FIG. 13C is an effective correction method in a case where the mesh data in the format not having normal information (that is, the format including only vertex coordinate information and topology information on the polygon) is utilized.

As above, according to the present embodiment, it is made possible to more reduce the difference in the shape of the mesh between the output tracks by correcting the tracked mesh selected as the output mesh.

### Third Embodiment

In recent years, it has also become more frequent that a colored point cloud is utilized as a 3D model of an object. In the tracking for continuous point cloud data also, as in the case of continuous mesh data, a feeling of incongruity occurs in the rapid movement of the rendering video due to the difference in shape between tracks. Consequently, an aspect is explained as a third embodiment in which the same tracking results as those of the first and second embodiments are obtained for continuous point cloud data. Explanation of the contents common to those of the first and second embodiments, such as the logic configuration and the hardware configuration of the image processing apparatus, is omitted and in the following, different points are explained mainly.

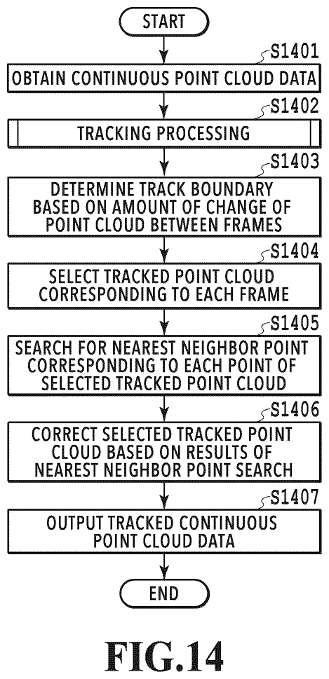

FIG. 14 is a flowchart showing a flow of the operation of the image processing apparatus 100 according to the present embodiment. In the following, with reference to FIG. 14, the operation of the image processing apparatus 100 according to the present embodiment is explained. In the following explanation, a symbol “S” means a step.

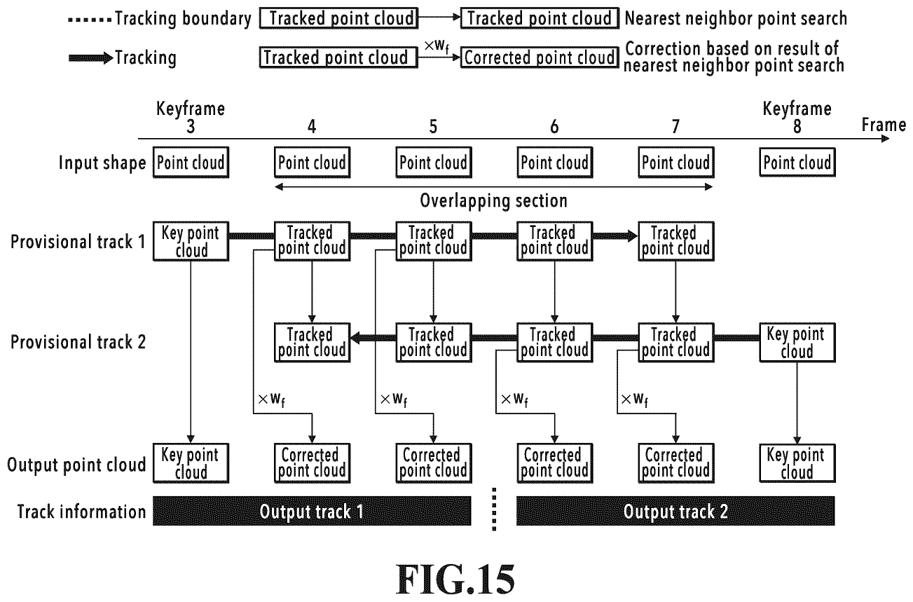

S1401 and S1402 correspond to S301 and S302 in the flow in FIG. 3 of the first embodiment and there is no difference basically except in that “mesh” is replaced with “point cloud”, and therefore, a detailed explanation is omitted. By the processing up to this point, the provisional tracked continuous point cloud data has been obtained. At the subsequent steps, processing to determine the track boundary for enabling the tracked point cloud shape to make a smoother transition between tracks and processing to correct the tracked point cloud selected as the output point cloud in each frame are performed. FIG. 15 is a diagram explaining the way the processing at S1403 and the subsequent steps is applied in a case where the overlapping section of interest is the fourth to seventh frames on a condition that continuous mesh data corresponding to the 12 frames shown in FIG. 4 is replaced with continuous point cloud data corresponding to 12 frames.

At S1403, the boundary determination unit 103 performs processing to determine a track boundary for obtaining an output track without overlapping section for the provisional tracked continuous point cloud data obtained at S1402. Specifically, first, the boundary determination unit 103 finds the amount of change in shape between frames of the input point cloud in the overlapping section. Then, the portion between frames at which the found amount of change in shape is the largest is determined to be the track boundary. By causing tracks to switch at the portion between frames at which the amount of change in shape is large as described above, it is possible to hide the difference in shape between tracks in the movement of a larger object. On the contrary to this, it is also possible to determine a track boundary so that tracks switch at the portion between frames at which the amount of change in shape is the smallest. The small amount of change in shape means that the failure of tracking is unlikely to occur, leading to a reduction in difference in shape between tracks. In this manner, the data format is changed to one in which each frame included in the provisional tracked continuous point cloud data belongs to one track. However, in this stage, the tracked point cloud that is associated with each frame is not determined, and therefore, at next S1404, the tracked point cloud is first associated with each frame.

At S1404, the shape generation unit 104 performs processing to select a tracked point cloud, which is taken as the point cloud (in the following, called “output point cloud”) corresponding to each frame configuring the output track. Specifically, the shape generation unit 104 selects the tracked point cloud in the provisional track that is adopted for the output track as the output point cloud for each frame included in the overlapping section. In the example in FIG. 15, for the fourth frame and the fifth frame of the output track 1, the tracked point clouds associated with the fourth frame and the fifth frame in the provisional track 1 are selected respectively as the output point cloud. Further, for the sixth frame and the seventh frame of the output track 2, the tracked point clouds associated with the sixth frame and the seventh frame in the provisional track 2 are selected respectively as the output point cloud. For the keyframe, the key point cloud already associated is maintained as it is as the output point cloud.

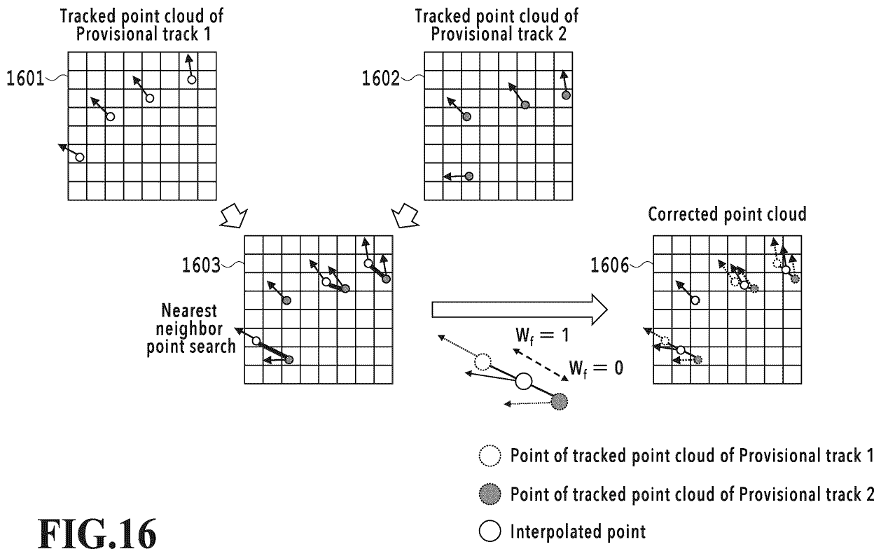

At S1405, the shape generation unit 104 makes a nearest neighbor point search from each point (corresponding to the vertex of mesh) of the tracked point cloud selected as the output point cloud in the output track to the tracked point cloud of another provisional track for each frame. Due to this, it is possible to obtain coordinate information on the nearest neighbor point and normal information in the tracked point cloud of another provisional track corresponding to each point of the tracked point cloud of the output track. FIG. 16 shows, as one example, results 1603 of making the nearest neighbor point search from each point of a tracked point cloud 1601 of the provisional track 1 according to the same frame to a tracked point cloud 1602 of the provisional track 2. As in FIG. 11 described previously, for convenience, FIG. 16 shows the tracked point cloud and the results of the nearest neighbor point search two-dimensionally, but the actual tracked point cloud and the actual results of the nearest neighbor point search have three-dimensional information.

At S1406, the shape generation unit 104 corrects the tracked point cloud selected as the output point cloud by weighted interpolation based on the results of the nearest neighbor point search, which are obtained at S1405. Specifically, the shape generation unit 104 obtains three-dimensional information on an intermediate point by interpolation by using a weight wr for each frame between each point of the selected tracked point cloud and the corresponding nearest neighbor point. Here, it is desirable to change the value of the weight wr linearly in accordance with the number of frames up to the adjacent keyframe like the weight in a case where the intermediate SDF is found in the second embodiment. Due to this, a point (interpolated point) having intermediate coordinates and normal is found, with which it is possible to cause the shapes of two tracks to make a smooth transition, and therefore, it is possible to obtain a corrected point cloud 1606 as shown in FIG. 16.

At S1407, the data output unit 105 outputs the tracked continuous point cloud data in which the corrected tracked point cloud is associated with each frame of each output track as the output point cloud, which is obtained by the processing up to this point, along with track information thereon. In the example in FIG. 15, with the third frame belonging to the output track 1, the key point cloud is associated as the output point cloud and with the fourth frame and the fifth frame belonging to the output track 1, the corrected point clouds of the tracked point cloud of the provisional track 1 are associated respectively as the output point cloud. Then, with the sixth frame and the seventh frame belonging to the output track 2, the corrected point clouds of the tracked point clouds of the provisional track 2 are associated as the output point cloud and with the eighth frame belonging to the output track 2, the key point cloud is associated as the output point cloud, respectively

The above is the flow of the operation in the image processing apparatus 100 according to the present embodiment. At S1406 described above, the example is explained in which information on the coordinates and the normal of each point configuring the point cloud is interpolated, but in a case where information other than the above-described information is appended to each point, it may also be possible to interpolate the other information. For example, in a case where the continuous point cloud data that is input is colored point cloud data having color information for each point, it may also be possible to interpolate information on the color and transparency, such as RGB values and the a-value, which is appended to each point. Alternatively, in a case where information on the size and the amount of deformation (amount of distortion) of each point is appended to each point as information that is applied in rendering, it may also be possible to interpolate information on the size and the mount of deformation. Further, in the present embodiment, the example is explained in which the output point cloud is corrected by the interpolation processing based on the results of the nearest neighbor point search in a case where the data format of the 3D model is the point cloud format, but it is also possible to apply the present embodiment to the case of the mesh format. That is, in place of the SDF described previously, it is also possible to correct the mesh shape by the interpolation processing with the nearest neighbor surface or the nearest neighbor point.

As above, according to the present embodiment, by correcting the tracked point cloud selected as the output point cloud, it is made possible to more reduce the difference in shape of the point cloud between output tracks as in the second embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, in tracking processing of a 3D model, it is possible to reduce the difference in shape between tracks.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-212061, filed Dec. 15, 2023 which is hereby incorporated by reference wherein in its entirety.

What is claimed is:

1. An image processing apparatus comprising:
one or more memories storing instructions; and
one or more processors executing the instructions for:
obtaining time-series shape data including a frame group consisting of a plurality of frames, each frame including a 3D model representing a three-dimensional shape of an object;
performing tracking processing for the time-series shape data so that an overlapping section occurs between adjacent tracks, wherein
the track indicates a frame section, which is a section in which a component of the 3D model is tracked between frames and in which a common topology is maintained; and
outputting tracked time-series shape data without overlapping section between adjacent tracks by taking one of positions within the overlapping section as a track boundary based on results of the tracking processing.

2. The image processing apparatus according to claim 1, wherein
the tracking processing is performed in two directions of a time-series direction and a reverse time-series direction based on a plurality of keyframes set for the frame group.

3. The image processing apparatus according to claim 2, wherein
the tracking processing is performed in the two directions with the number of frames exceeding half an interval between adjacent keyframes.

4. The image processing apparatus according to claim 3, wherein
the tracking processing is performed in the two directions by taking a section from a certain keyframe to the next keyframe as one track.

5. The image processing apparatus according to claim 1, wherein
the tracking processing is performed in one of a time-series direction and a reverse time-series direction based on a plurality of keyframes set for the frame group.

6. The image processing apparatus according to claim 5, wherein
the tracking processing is performed in the one direction by taking a section from a certain keyframe to several frames beyond a keyframe adjacent to the certain frame as one track.

7. The image processing apparatus according to claim 1, wherein
the one or more processors further execute the instructions for:
determining the track boundary based on a difference between shapes represented by a tracked 3D model of each of the adjacent tracks in each frame included in the overlapping section.

8. The image processing apparatus according to claim 7, wherein
in the determining:
a degree of similarity in shape represented by a tracked 3D model of each of the adjacent tracks is calculated for each frame included in the overlapping section;
a frame pair whose calculated degree of similarity in shape is high is identified; and
a portion between the identified frame pair is determined as the track boundary.

9. The image processing apparatus according to claim 8, wherein
in the determining:
a combination of a frame whose degree of similarity in shape is the highest among each frame included in the overlapping section and a frame whose degree of similarity in shape is higher of both frames adjacent to the frame is identified as the frame pair.

10. The image processing apparatus according to claim 8, wherein
in the determining:
a combination with which the total sum of the degrees of similarity in shape in two adjacent frames among each frame included in the overlapping section is the maximum is identified as the frame pair.

11. The image processing apparatus according to claim 8, wherein
the degree of similarity in shape is a value of evaluation using a Hausdorff distance based on a shape represented by the tracked 3D model.

12. The image processing apparatus according to claim 8, wherein
the degree of similarity in shape is a value of evaluation using a cosine similarity based on a normal of the tracked 3D model.

13. The image processing apparatus according to claim 1, wherein
the one or more processors further execute the instructions for:
finding a signed distance field of a tracked 3D model of each of the adjacent tracks in each frame included in the overlapping section and determining the track boundary based on the degree of similarity in the found signed distance field.

14. The image processing apparatus according to claim 7, wherein
in the determining:
an amount of change in shape between frames of a 3D model associated with each frame of the time-series shape data is found in the overlapping section; and
a portion between frames at which the amount of change in shape is the largest is determined as the track boundary.

15. The image processing apparatus according to claim 7, wherein
in the determining:
an amount of change in shape between frames of a 3D model associated with each frame of the time-series shape data is found in the overlapping section; and
a portion between frames at which the amount of change in shape is the smallest is determined as the track boundary.

16. The image processing apparatus according to claim 7, wherein
the one or more processors further execute the instructions for:
generating a tracked 3D model corresponding to each frame of each track configuring the tracked time-series shape data based on the determined track boundary.

17. The image processing apparatus according to claim 16, wherein
in the generating:
a tracked 3D model corresponding to each frame of each track configuring the tracked time-series shape data is generated by selecting one of tracked 3D models of each of the adjacent tracks based on the determined track boundary.

18. The image processing apparatus according to claim 16, wherein
in the generating:
a tracked 3D model corresponding to each frame of each track configuring the tracked time-series shape data is generated by correcting a tracked 3D model selected from among tracked 3D models of each of the adjacent tracks based on the determined track boundary.

19. The image processing apparatus according to claim 18, wherein
in the correcting, information appended to each vertex of a component of the selected tracked 3D model is corrected.

20. The image processing apparatus according to claim 19, wherein
in the correcting, at least one of coordinates and a normal of a component is corrected as information appended to a vertex of the component of the selected tracked 3D model.

21. The image processing apparatus according to claim 19, wherein
in the correcting, at least one of color and transparency of a component is corrected as information appended to a vertex of the component of the selected tracked 3D model.

22. The image processing apparatus according to claim 19, wherein
in the correcting, at least one of size and amount of change of each component, which is applied in a case of rendering, is corrected as information appended to a vertex of the component of the selected tracked 3D model.

23. The image processing apparatus according to claim 19, wherein
in the generating:
a signed distance field of a tracked 3D model of each of the adjacent tracks is calculated;
an intermediate signed distance field is calculated for each frame included in the overlapping section based on the calculated signed distance field; and
the correcting is performed based on the intermediate signed distance field calculated for each frame.

24. The image processing apparatus according to claim 19, wherein
in the generating:
a nearest neighbor surface or a nearest neighbor point from a component of the selected tracked 3D model to a component of a tracked 3D model that is not selected is searched for; and
the correcting is performed by a weighted interpolation using results of the search.

25. The image processing apparatus according to claim 24, wherein a value of weight in the weighted interpolation change linearly in accordance with the number of frames up to the adjacent keyframe.

26. The image processing apparatus according to claim 1, wherein
the time-series shape data is data in a mesh format using polygons as a component of the 3D model.

27. The image processing apparatus according to claim 1, wherein
the time-series shape data is data in a point cloud format using points as a component of the 3D model.

28. An image processing method comprising the steps of:
obtaining time-series shape data including a frame group consisting of a plurality of frames, each frame including a 3D model representing a three-dimensional shape of an object;
performing tracking processing for the time-series shape data so that an overlapping section occurs between adjacent tracks, wherein
the track indicates a frame section, which is a section in which a component of the 3D model is tracked between frames and in which a common topology is maintained; and
outputting tracked time-series shape data without overlapping section between adjacent tracks by taking one of positions within the overlapping section as a track boundary based on results of the tracking processing.

29. A non-transitory computer readable storage medium storing a program for causing a computer to perform an image processing method comprising the steps of:
obtaining time-series shape data including a frame group consisting of a plurality of frames, each frame including a 3D model representing a three-dimensional shape of an object;
performing tracking processing for the time-series shape data so that an overlapping section occurs between adjacent tracks, wherein
the track indicates a frame section, which is a section in which a component of the 3D model is tracked between frames and in which a common topology is maintained; and
outputting tracked time-series shape data without overlapping section between adjacent tracks by taking one of positions within the overlapping section as a track boundary based on results of the tracking processing.
